(19) United States
(12) Patent Application Publication
(10) Pub. No.: US 2026/0044695 A1
(43) Pub. Date: Feb. 12, 2026

(54) METHOD OF GENERATING LEARNING DATA, LEARNING MODEL, INFORMATION PROCESSING APPARATUS, AND METHOD OF PROCESSING INFORMATION

(71) Applicant: KYOCERA Corporation, Kyoto (JP)

(72) Inventors: Yisan HSIEH, Yokohama-shi, Kanagawa (JP); Xiaoyan DAI, Yokohama-shi, Kanagawa (JP)

(73) Assignee: KYOCERA Corporation, Kyoto (JP)

(21) Appl. No.: 18/998,450

(22) PCT Filed: Jul. 5, 2023
(86) PCT No.: PCT/JP2023/025020

§ 371 Date: Jan. 24, 2025

(30) Foreign Application Priority Data
Jul. 27, 2022 (JP) 2022-119999

(51) Int. Cl. G06K 7/14; G06K 19/06; G06T 3/08; G06T 3/40; G06T 11/00; G06T 11/60

(52) U.S. Cl. CPC G06K 7/1413; G06K 19/06028; G06T 3/08; G06T 3/40; G06T 11/001; G06T 11/60; G06T 2210/62

(57) ABSTRACT

A method of generating learning data includes: generating a first code image that is a graphical code; generating a second code image by applying first image processing to the first code image; and generating a first image by superposing the second code image onto a background image.

### CROSS-REFERENCE TO RELATED APPLICATIONS

This application claims priority from Japanese Patent Application No. 2022-119999 (filed Jul. 27, 2022), the content of which is all incorporated herein by reference.

### TECHNICAL FIELD

The present disclosure relates to a method of generating learning data, a learning model, an information processing apparatus, and a method of processing information.

### BACKGROUND OF INVENTION

Attaching a barcode to a package or the like of a product is known, and information by which to identify the product is encoded into the barcode. A dedicated device configured to read barcodes, such as a barcode scanner and a touch scanner, is used to scan the barcode, and thereby the encoded information is decoded (refer to Patent Literature 1).

### CITATION LIST

### Patent Literature

Patent Literature 1: Japanese Unexamined Patent Application Publication No. 2015-153224

### SUMMARY

According to a first aspect, a method of generating learning data includes
generating a first code image that is a graphical code;
generating a second code image by applying first image processing to the first code image; and
generating a first image by superposing the second code image onto a background image.

According to a second aspect, a learning model is configured to
cause a computer to, in response to an image being input, output an area of a partial image corresponding to a graphical code in the image, the learning model being trained using a second image generated by a method of generating learning data, the method including generating a first code image that is a graphical code, generating a second code image by applying first image processing to the first code image, generating a first image by superposing the second code image onto a background image, and generating a second image by applying second image processing to the first image, the second image processing being changing at least one of color or contrast of the first image as a whole.

According to a third aspect, a learning model is configured to
cause a computer to, in response to an image being input, output an area of a partial image corresponding to a graphical code in the image, the learning model being trained using a first image generated by a method of generating learning data, the method including generating a first code image that is a graphical code, generating a second code image by applying first image processing to the first code image, and generating a first image by superposing the second code image onto a background image.

According to a fourth aspect, an information processing apparatus includes
an acquirer configured to acquire a captured image that has been captured; and
a controller configured to extract a partial image corresponding to a graphical code by entering the captured image into a detection model and decode the code based on the extracted partial image, and
the detection model is a learning model configured to cause a computer to, in response to an image being input, output an area of a partial image corresponding to a graphical code in the image, the learning model being trained using a second image generated by a method of generating learning data, the method including generating a first code image that is a graphical code, generating a second code image by applying first image processing to the first code image, generating a first image by superposing the second code image onto a background image, and generating a second image by applying second image processing to the first image, the second image processing being changing at least one of color or contrast of the first image as a whole.

According to a fifth aspect, a method of processing information includes
acquiring a captured image that has been captured;
extracting a partial image corresponding to a graphical code by entering the captured image into a detection model; and
decoding the code based on the extracted partial image, and
the detection model is a learning model configured to cause a computer to, in response to an image being input, output an area of a partial image corresponding to a graphical code in the image, the learning model being trained using a second image generated by a method of generating learning data, the method including generating a first code image that is a graphical code, generating a second code image by applying first image processing to the first code image, generating a first image by superposing the second code image onto a background image, and generating a second image by applying second image processing to the first image, the second image processing being changing at least one of color or contrast of the first image as a whole.

According to a sixth aspect, a method of generating learning data includes
generating a first code image to be used to identify an attribute of an article;
generating a second code image by applying first image processing to the first code image; and
generating a learning image by superposing the second code image onto a background image including images of the article and a package containing the article, and
the first image processing is configured to reproduce a manner in which at least one of the article or the package containing the article is visible through the first code image.

### BRIEF DESCRIPTION OF THE DRAWINGS

FIG. 1 is a configuration diagram illustrating a schematic configuration of an information processing system including an information processing apparatus according to an embodiment.

FIG. 2 is a block diagram illustrating a schematic configuration of a terminal in FIG. 1.

FIG. 3 is a block diagram illustrating a schematic configuration of a first information processing apparatus in FIG. 2.

FIG. 4 is a first diagram for describing a process for decoding a code in the first information processing apparatus in FIG. 3.

FIG. 5 is a second diagram for describing a process for decoding a code in the first information processing apparatus in FIG. 3.

FIG. 6 is a block diagram illustrating a schematic configuration of a second information processing apparatus in FIG. 2.

FIG. 7 is a block diagram illustrating a schematic configuration of a third information processing apparatus configured to perform a method of generating learning data according to an embodiment.

FIG. 8 is a picture illustrating an example of a third code image.

FIG. 9 is a picture illustrating another example of a third code image.

FIG. 10 is a flowchart for describing a decoding process performed by a controller in FIG. 3.

FIG. 11 is a flowchart for describing a learning-data generation process performed by a controller in FIG. 7.

### DESCRIPTION OF EMBODIMENTS

In the related art, decoding a graphical code such as a barcode requires the code to be read with a dedicated scanner or an image of the code to be captured with a camera. Reading a code and capturing an image of a code both, however, require the code to be properly aligned and properly positioned relative to a scanner or a camera. Expertise of an operator is necessary for such alignment and positioning. A graphical code needs to be decoded promptly, and capability of promptly and readily decoding a code has been desired. In view of the above issues, the present disclosure provides a prompt and simple way of decoding a graphical code with high accuracy.

An embodiment of the present disclosure will be described hereinafter with reference to the drawings. The same elements in the drawings below are denoted by the same symbols.

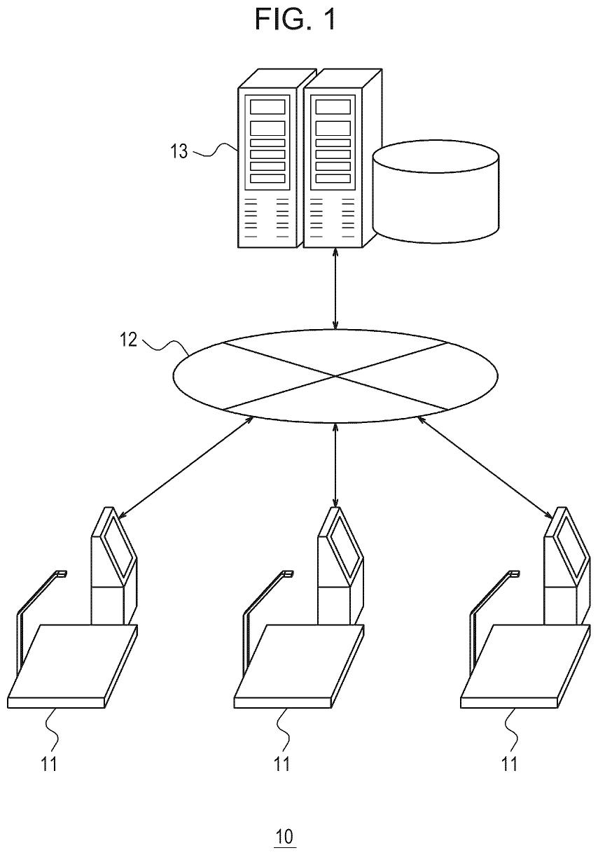

As illustrated in FIG. 1, in an embodiment of the present disclosure, an information processing system 10 including a first information processing apparatus (information processing apparatus) includes at least one terminal 11, a network 12, and a second information processing apparatus 13. In an embodiment, the information processing system 10 includes multiple terminals 11. The terminals 11 and the second information processing apparatus 13 may communicate via the network 12.

The information processing system 10 is applied to any system configured to identify a detection target based on an image of the detection target included in an image. For example, the information processing system 10 is applied to a payment system configured to identify a product, which is a detection target, based on an image. Hereinafter, description will be given with regard to the information processing system 10, which is applied to a payment system as an example.

The information processing system 10, which is applied to a payment system, is used for payment for a product. A product has a graphical code on a surface or a package. A graphical code provides product-identifying information encoded based on any encoding algorithm. Examples of a graphical code include a one-dimensional code such as a barcode and a two-dimensional code such as a QR code (registered trademark). The product-identifying information may be information, such as an identification number, assigned to each product name or each product to identify the product.

The terminal 11 may capture an image of a product. The terminal 11 may detect and decode a graphical code in the image generated by the image capturing. The terminal 11 may recognize product-identifying information through decoding. The second information processing apparatus 13 may calculate an asking price based on the product-identifying information. The terminal 11 may present the asking price to a purchaser and request payment of a purchase price.

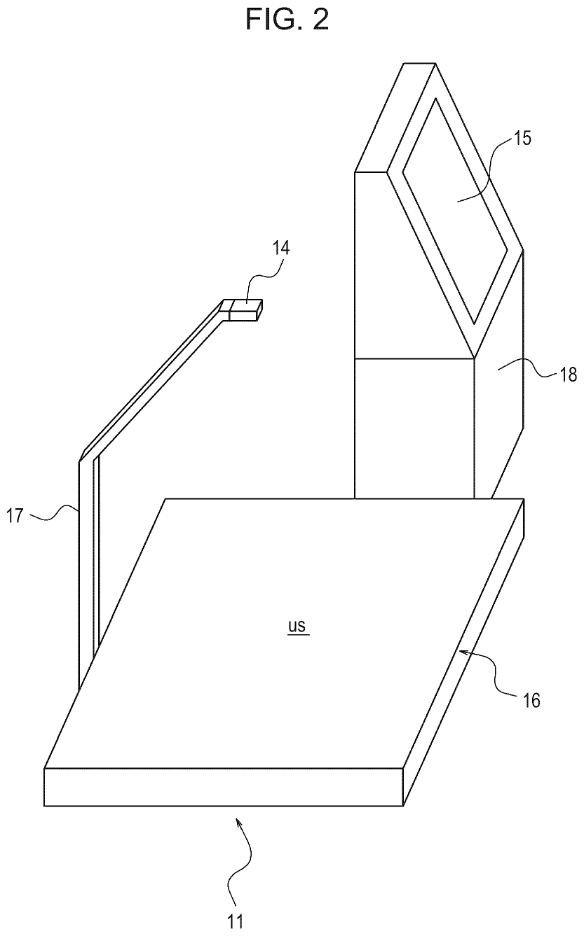

As illustrated in FIG. 2, the terminal 11 may include an imager 14, an output device 15, a platen 16, a supporting stand 17, and a first information processing apparatus 18.

For example, the imager 14 is fixed in a manner that enables capturing an image of at least a partial area of the platen 16. For example, the imager 14 is fixed to the supporting stand 17 extending from a side surface of the platen 16. For example, the imager 14 is fixed in a manner that enables capturing an image of the entire upper surface us of the platen 16 and that allows the optical axis to be perpendicular to the upper surface us. The imager 14 may capture a moving image. In other words, the imager 14 may continuously generate captured images at a predetermined frame rate. A captured image may be an analog signal or digital data.

The imager 14 may include a visible-light or infrared camera. The camera includes imaging optics and an imaging element. The imaging optics include optical components such as one or more lenses and apertures. The one or more lenses may be of any type irrespective of a focal length, and examples of the one or more lenses include a general-purpose lens, a wide-angle lens including a fisheye lens, and a zoom lens having a variable focal length. The imaging optics are configured to form a subject image on a light receiving surface of the imaging element. Examples of the imaging element include a CCD (charge coupled device) image sensor, a CMOS (complementary metal-oxide semiconductor) image sensor, and an FIR (far infrared rays) camera. The imaging element is configured to capture the subject image formed on the light receiving surface and generate a captured image.

The output device 15 may be any type of display known in the art configured to present an image. The display may serve as a touch screen as described below. The output device 15 may be a loudspeaker configured to report information. For example, the output device 15 may output product-identifying information obtained by decoding a graphical code in the first information processing apparatus 18. The output device 15 may provide various reports, for example, when malfunction occurs in the information processing system 10 or the like. When a graphical code is not properly decoded, the output device 15 may output an instruction to change direction of the product. The output device 15 may output information regarding whether decoding by the first information processing apparatus 18 is successful and an instruction to change positioning of the product.

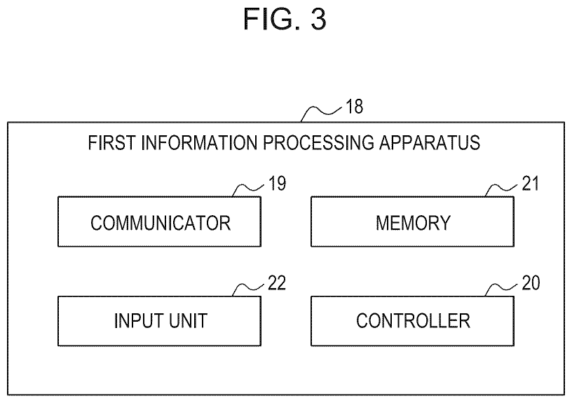

As illustrated in FIG. 3, the first information processing apparatus 18 includes a communicator 19 (acquirer) and a controller 20. The first information processing apparatus 18 may further include a memory 21 and an input unit 22. In an embodiment, the first information processing apparatus 18 is separate from the imager 14 and the output device 15 but may be integrated, for example, with at least any one of the imager 14, the platen 16, the supporting stand 17, and the output device 15.

The communicator 19 includes, for example, a communication module configured to communicate with the imager 14 via a communication line including a wireline or wireless communication line. The communicator 19 is configured to acquire a captured image from the imager 14. The communicator 19 may include a communication module configured to communicate with the output device 15 via a communication line. The communicator 19 may transmit an image to be presented to the output device 15 as an image signal. The communicator 19 may receive from the output device 15, which is a display, a position signal corresponding to a position at which contact is detected on the display surface. The communicator 19 may include a communication module configured to communicate with the second information processing apparatus 13 via the network 12. The communicator 19 may receive from the second information processing apparatus 13 a parameter for building a detection model, which is described below. The parameter may be an analog signal or digital data. The communicator 19 may transmit to the second information processing apparatus 13 decoded product-identifying information, which is described below. The product-identifying information may be an analog signal or digital data. The communicator 19 may receive from the second information processing apparatus 13 price information corresponding to an asking price. The price information may be an analog signal or digital data.

The input unit 22 is able to detect an operation input from a user. The input unit 22 includes at least one input interface capable of detecting an input from the user. Examples of the at least one input interface include a physical key, a capacitive key, a pointing device, a touch screen integrated with a display, and a microphone. In an embodiment, an input/output interface is a touch screen based on the output device 15.

The memory 21 includes any one of a semiconductor memory, a magnetic memory, and an optical memory. Examples of the semiconductor memory include a RAM (random access memory) and a ROM (read only memory). Examples of the RAM include an SRAM (static random access memory) and a DRAM (dynamic random access memory). Examples of the ROM include an EEPROM (electrically erasable programmable read only memory). The memory 21 may serve as a main storage device, an auxiliary storage device, or a cache memory. The memory 21 is configured to store data to be used for operation of the first information processing apparatus 18 and data obtained by operation of the first information processing apparatus 18. For example, the memory 21 is configured to store a system program, an application program, embedded software, and the like. For example, the memory 21 is configured to store a parameter acquired from the second information processing apparatus 13 to build a detection model.

The controller 20 includes at least one processor, at least one dedicated circuit, or a combination thereof. Examples of the at least one processor include a general-purpose processor, such as a CPU (central processing unit) or a GPU (graphics processing unit), and a dedicated processor configured to specialize in specific processing. Examples of the at least one dedicated circuit may include an FPGA (field-programmable gate array) and an ASIC (application specific integrated circuit). The controller 20 is configured to perform a process concerning the operation of the first information processing apparatus 18 while controlling each unit in the first information processing apparatus 18.

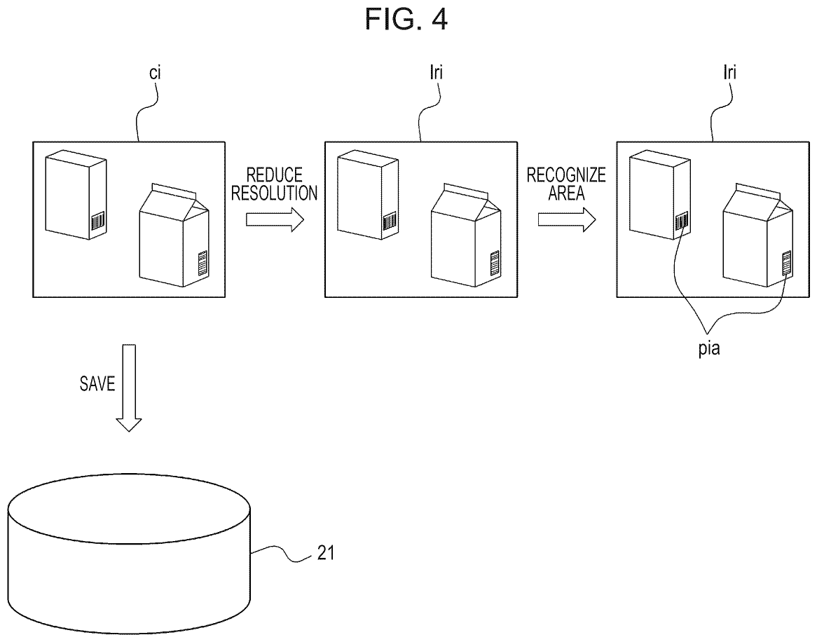

As illustrated in FIG. 4, the controller 20 may save to the memory 21 a captured image ci acquired via the communicator 19. The controller 20 may generate a low-resolution image Iri by reducing resolution of the captured image ci as a whole, which is stored in the memory 21. The controller 20 may reduce the resolution of the captured image ci by using a known image processing technique such as LPF (low pass filter). The low-resolution image Iri may be an analog signal or digital data.

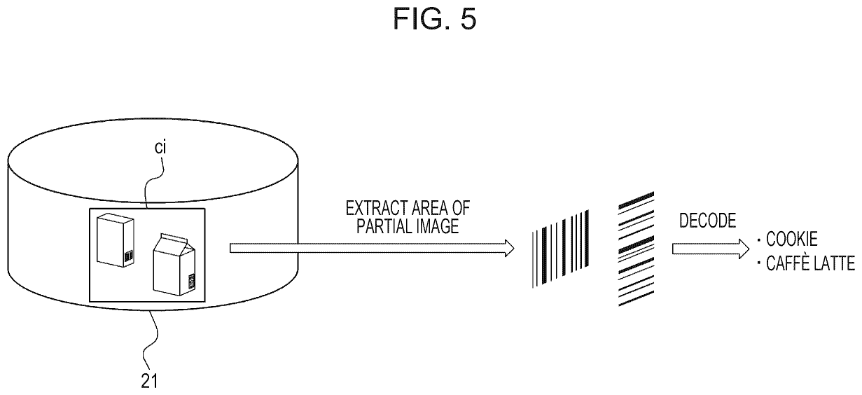

The controller 20 is configured to enter the captured image ci into a detection model and thereby detect an area of a partial image pia corresponding to a graphical code in the captured image ci. Alternatively, the controller 20 is configured to enter the low-resolution image Iri instead of the captured image ci into a detection model and thereby detect an area of a partial image pia corresponding to a graphical code in the low-resolution image Iri. The detection model may detect a graphical code in the entire image and deduce an area occupied by the code. The area occupied by the code may be an analog signal or digital data. The detection model may be a learning model described below. As illustrated in FIG. 5, for example, the controller 20 is configured to extract a partial image in the area pia from the captured image ci stored in the memory 21. The controller 20 may extract the multiple areas pia. The partial image may be an analog signal or digital data. The controller 20 is configured to decode the graphical code based on the partial image in the area pia that has been extracted.

When the detection model is used to detect the area of a partial image pia corresponding to the code and the reliability of detection is equal to or less than a reliability threshold, the controller 20 may cause the output device 15 to output a request to direct the graphical code toward the imager 14. Alternatively, when the controller 20 is unable to decode the graphical code based on the partial image in the area pia that has been extracted, the controller 20 may cause the output device 15 to output a request to direct the graphical code toward the imager 14. For example, if the controller 20 has a sufficiently large processing capacity to detect the partial area pia corresponding to the graphical code, the controller 20 may use the captured image ci as the input into the detection model to decode the code instead of using the low-resolution image Iri as described above.

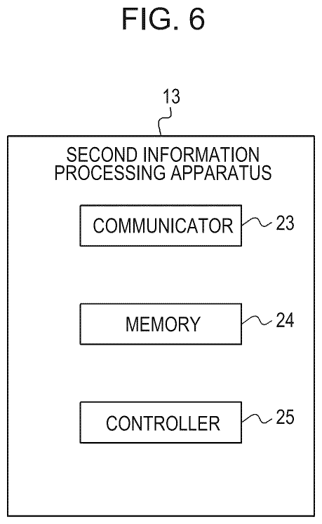

As illustrated in FIG. 6, the second information processing apparatus 13 may include a communicator 23, a memory 24, and a controller 25.

The communicator 23 may include at least one communication module capable of connecting to the network 12. The at least one communication module is configured to support a communication standard such as wireline LAN (local area network), wireless LAN, or Wi-Fi. The communicator 23 may be connected to the network 12 by the at least one communication module via the wireline LAN or the like.

The communicator 23 may include, for example, a communication module capable of communicating with various external apparatuses via a communication line. The communication module is configured to support a standard for the communication line. The communication line may include at least any one of wireline and wireless communication.

The memory 24 includes any one of a semiconductor memory, a magnetic memory, and an optical memory. Examples of the semiconductor memory include a RAM and a ROM. Examples of the RAM include an SRAM and a DRAM. Examples of the ROM include an EEPROM. The memory 24 may serve as a main storage device, an auxiliary storage device, or a cache memory. The memory 24 is configured to store data to be used for operation of the second information processing apparatus 13. For example, the memory 24 is configured to store a system program, an application program, embedded software, and the like. For example, the memory 24 is configured to store a sales price of each product registered in a production system.

The controller 25 includes at least one processor, at least one dedicated circuit, or a combination thereof. Examples of the at least one processor include a general-purpose processor, such as a CPU or a GPU, and a dedicated processor configured to specialize in specific processing. Examples of the at least one dedicated circuit may include an FPGA and an ASIC. The controller 25 is configured to perform a process concerning the operation of the second information processing apparatus 13 while controlling each unit in the second information processing apparatus 13.

Upon acquiring decoded product-identifying information from the terminal 11, the controller 25 may retrieve from the memory 24 a sales price of a product corresponding to the product-identifying information. The controller 25 may add up sales prices of products to obtain an asking price. The controller 25 may transmit price information corresponding to the asking price to the terminal 11, which has provided the product-identifying information.

The detection model used in the first information processing apparatus 18 described above is a learning model trained using, as supervised data, a combination of an image including, as a partial image, a product having a graphical code on a surface and information indicating a position of the code. Description will be given below with regard to a method of generating supervised data as learning data.

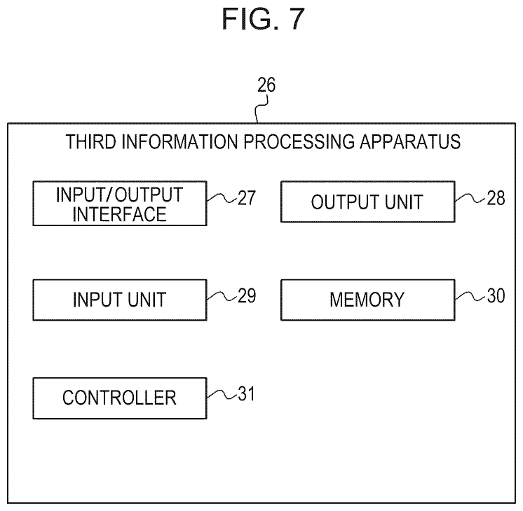

For example, as illustrated in FIG. 7, a third information processing apparatus 26 may generate the learning data. The third information processing apparatus 26 may be a general-purpose information processing apparatus, such as a PC (personal computer) or a server apparatus, or a dedicated information processing apparatus. The third information processing apparatus 26 may include an input/output interface 27, an output unit 28, an input unit 29, a memory 30, and a controller 31.

The input/output interface 27 is configured to output and receive data to and from, for example, a camera or another information processing apparatus directly or indirectly via a network. For example, the input/output interface 27 may acquire text information to generate a first code image that is a graphical code. The text information may be an analog signal or digital data. The text information may be any information, such as meaningful information or meaningless information in which characters or the like are simply sequenced.

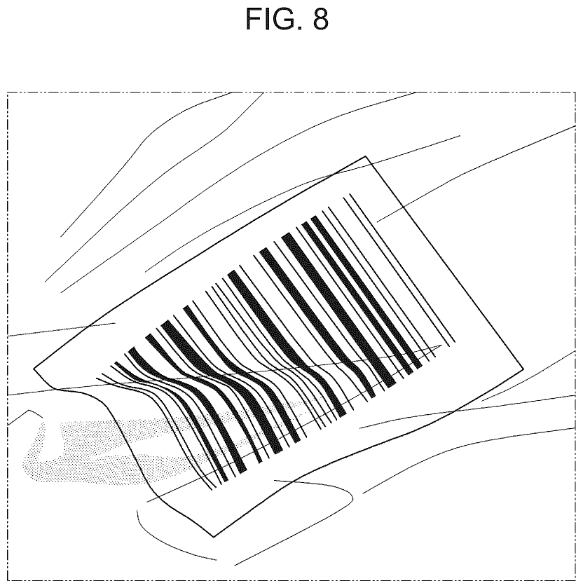

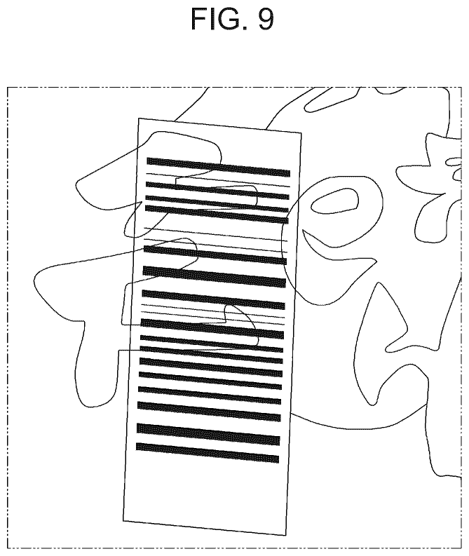

The input/output interface 27 may acquire a third code image that has been generated from a captured image of an existing graphical code. The third code image may be an analog signal or digital data. Examples of the third code image preferably include not only a captured image of a code viewed from the front but also captured images viewed from various directions. In addition, as illustrated in FIG. 8, examples of the third code image preferably include an image of a code that is drawn on a flexible package and that is captured while the code is bent and deformed. Further, examples of the third code image preferably include an image of a code that is captured out of focus and blurred. Further, as illustrated in FIG. 9, examples of the third code image preferably include an image of a graphical code through which an underlying picture is visible.

The input/output interface 27 may acquire a background image. The background image may be an analog signal or digital data. The background image is a wide-area image including a target, such as a product or a package of the product, on which a graphical code is drawn. For example, the wide-area image may be an image in which a target placed on a platen or the like is captured together with an upper surface of the platen.

The output unit 28 may include one or more interfaces configured to output information and report on the information to a user. Non-limiting examples of the output unit 28 include a display configured to output information using a video image and a loudspeaker configured to output information using voice.

The input unit 29 may include one or more interfaces configured to detect input from the user. Examples of the input unit 29 include a physical key, a capacitive key, and a touch screen integrated with the display in the output unit 28.

The memory 30 includes any one of a semiconductor memory, a magnetic memory, and an optical memory. Examples of the semiconductor memory include a RAM and a ROM. Examples of the RAM include an SRAM and a DRAM. Examples of the ROM include an EEPROM. The memory 30 may serve as a main storage device, an auxiliary storage device, or a cache memory. The memory 30 is configured to store data to be used for operation of the third information processing apparatus 26. For example, the memory 30 is configured to store a system program, an application program, embedded software, and the like. For example, the memory 30 may store text information, a third code image, and a background image acquired via the input/output interface 27.

The controller 31 includes at least one processor, at least one dedicated circuit, or a combination thereof. Examples of the at least one processor include a general-purpose processor, such as a CPU or a GPU, and a dedicated processor configured to specialize in specific processing. Examples of the at least one dedicated circuit may include an FPGA and an ASIC. The controller 31 is configured to perform a process concerning the operation of the third information processing apparatus 26 while controlling each unit in the third information processing apparatus 26.

The controller 31 is configured to generate the first code image that is a graphical code. The first code image may be an analog signal or digital data. The controller 31 may generate the first code image by encoding text information acquired by the input/output interface 27 and the input unit 29. Alternatively, for example, the controller 31 may generate text information by randomly sequencing a predetermined number of characters and generate the first code image by encoding the text information. The controller 31 may perform encoding using any encoding algorithm.

The controller 31 may generate learning data using the third code images separately from the first code images. When using the third code images to generate the learning data, the controller 31 may determine the number of the first code images to be generated based on the number of the third code images that are acquired. The number of the first code images and the number of the third code images are each the number of codes that may be decoded into independent identifying information. The number of the first code images to be generated may be equal to the number of the third code images.

The controller 31 is configured to generate a second code image by applying first image processing to a first code image. The second code image may be an analog signal or digital data. The first image processing may reproduce deformation of a graphical code including warping and bending caused by deformation including warping and bending of an article or a package to which the graphical code is attached. The first image processing may reproduce deformation of a graphical code caused when an article or a package to which the graphical code is attached is placed on the platen 16. The first image processing may reproduce various directions that a graphical code faces relative to the imaging device 14 when an article or a package to which the graphical code is attached is placed on the platen 16. The first image processing may reproduce blurring due to defocusing of the imaging device 14 resulting from the size of an article or a package to which a graphical code is attached. The first image processing may reproduce various sizes of a graphical code resulting from a distance from the imaging device 14. The first image processing may reproduce transparency resulting from a property of material of an article or a package to which a graphical code is attached. The first image processing may reproduce in a graphical code a situation that occurs in the surroundings when an article or a package to which the graphical code is attached is placed on the platen 16, for example, partial whiteout caused by reflection of light from a light source.

Thus, the first image processing may include at least one selected from the group consisting of rotation, enlargement or reduction, distortion, blurring, transparency processing, and local color change. The first image processing may be composed of a combination of at least two selected from the group consisting of rotation, enlargement or reduction, distortion, blurring, transparency processing, and local color change. Distortion may be a process of reproducing a manner in which a graphical code is changed in accordance with a three-dimensional shape of an article, such as bending of the article, on which the graphical code is drawn. Distortion may be a process of reproducing a manner in which a graphical code is changed in accordance with a three-dimensional shape of a flexible package, such as warping and bending of the package, on which the graphical code is drawn, for example, as illustrated in FIG. 8. Transparency processing may be a process of reproducing a manner that allows one of or both of an article and a package containing the article to be visible through a graphical code, for example, as illustrated in FIG. 9. The transparency processing may be a process of reproducing a manner in which, for example, the graphical code appears mixed with a picture or a character drawn on the article or the package by changing transmittance of at least part of the first code image, considering the property of the material to which the graphical code is attached. The local color change is a process of increasing luminance in the actual captured image ci, for example, like a shiny surface on which a graphical code is drawn. The first image processing may be the same for all the first code images or may differ.

The controller 31 may generate a second code image by applying the first image processing to a third code image. The first image processing may be the same for all the third code images or may differ. If the number of the first code images that have been generated exceeds the number of the third code images, the controller 31 may make the number of the second code images generated for each of the third code images larger than the number of the second code images generated for each of the first code images so that the total number of the second code images based on the first code images matches the total number of the second code images based on the third code images.

The controller 31 is configured to generate a first image by superposing a second code image onto a background image. The first image may be an analog signal or digital data. The controller 31 may superpose the second code image, in particular, onto a target in the background image. Examples of the target may include an article. Examples of the target may include a packaged item (an article and a package containing the article). The package may be a wrapping film or a packaging container that allows a contained article to be visible. The package may be wrapping paper, a wrapping film, or a packaging container that does not allow a contained article to be visible. If the background image includes a packaged item, upon generating the second code image by applying the transparency processing as the first image processing, the controller 31 may generate the first image in which one of or both of an article and a package containing the article are visible through the second code image. If the background image includes a packaged item that allows a contained article to be visible, upon generating the second code image by applying the transparency processing as the first image processing, the controller 31 may generate the first image in which the article contained in the package and another underlying target disposed under the package are visible. When performing processing including the transparency processing as the first image processing to generate the second code image and superposing the second code image onto the target, the controller 31 may generate the first image in which the second code image appears mixed with the target. The controller 31 may superpose each second code image onto multiple background images and generate multiple first images for each second code image. The controller 31 may generate a first image based on a third code image. The first image based on the third code image may include an image generated by superposing onto the background image the second code image generated by applying the first image processing to the third code image. Alternatively, the first image based on the third code image may include an image generated by superposing the third code image onto the background image without applying the first image processing to the third code image. The controller 31 may recognize positional information indicating an area onto which the second code image is superposed when the second code image is superposed onto the background image.

The controller 31 may generate a second image by applying second image processing to a first image. The second image may be an analog signal or digital data. The second image processing may reproduce a change resulting from a model of the imaging device 16 and settings for image capturing. The second image processing may reproduce a change resulting from the settings for image capturing in the imaging device 16. The second image processing may reproduce a change in appearance that occurs due to an illuminance value when the imaging device 16 captures an image of a graphical code. Thus, the second image processing changes at least one of color or contrast of the first image as a whole. Examples of the change in color include a change in hue, saturation, and brightness. The second image processing may be the same for all the second code images or may differ.

The controller 31 may associate, as supervised data, the second image that has been generated with positional information indicating an area onto which the second code image is superposed in the second image and save to the memory 30 the second image and the positional information in association with each other. In generating the supervised data, to increase the number of pieces of supervised data in a simple way to improve detection accuracy, the controller 31 may associate, as the supervised data, the first image that has been generated with positional information indicating an area onto which the second code image is superposed in the first image and save to the memory 30 the first image and the positional information in association with each other.

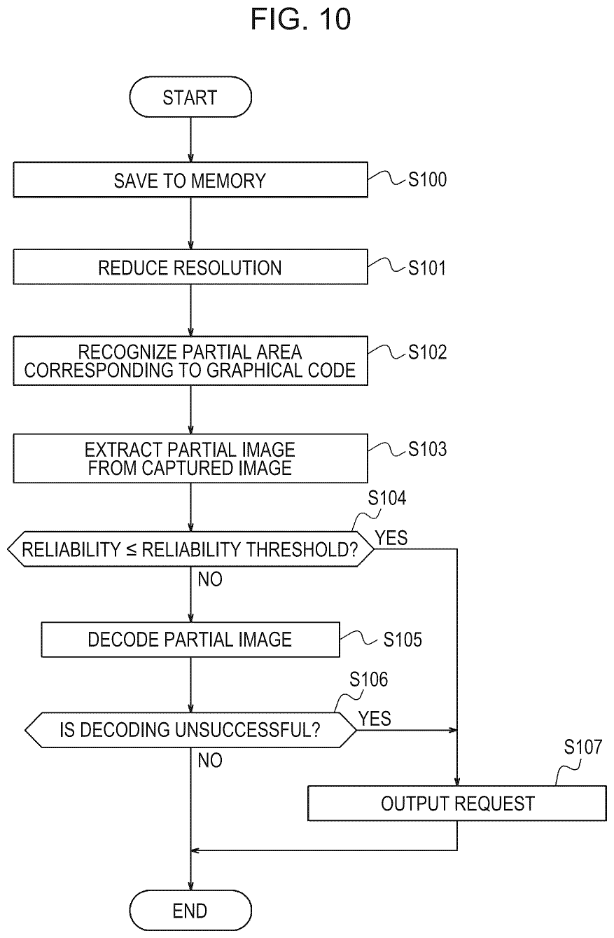

Referring to a flowchart in FIG. 10, description will be given with regard to a decoding process performed by the controller 20 in the first information processing apparatus 18 in an embodiment. The decoding process starts whenever the communicator 19 in the first information processing apparatus 18 acquires a frame of the captured image ci.

In step S100, the controller 20 saves the acquired captured image ci to the memory 21. After the saving, the process proceeds to step S101.

In step S101, the controller 20 generates the low-resolution image Iri by reducing the resolution of the captured image as a whole. After the generation, the process proceeds to step S102.

In step S102, the controller 20 detects the area of a partial image pia corresponding to a graphical code by entering the low-resolution image Iri generated in step S101 into the detection model. After the detection, the process proceeds to step S103.

In step S103, the controller 20 extracts, from the captured image ci saved to the memory 21 in step S100, a partial image in an area located at the same position as the area pia detected in step S102. After the extraction, the process proceeds to step S104.

In step S104, the controller 20 determines whether the reliability of the detection in step S102 is equal to or less than the reliability threshold. If the reliability is equal to the reliability threshold or less, the process proceeds to step S107. If the reliability is neither equal to the reliability threshold nor less, the process proceeds to step S105.

In step S105, the controller 20 decodes the graphical code based on the partial image extracted in step S103. After the decoding, the process proceeds to step S106.

In step S106, the controller 20 determines whether the decoding in step S105 is unsuccessful. If the decoding is unsuccessful, the process proceeds to step S107. If the decoding is successful, the decoding process ends.

In step S107, the controller 20 causes the output device 15 to output a request to direct the graphical code toward the imager 14. After the output, the decoding process ends.

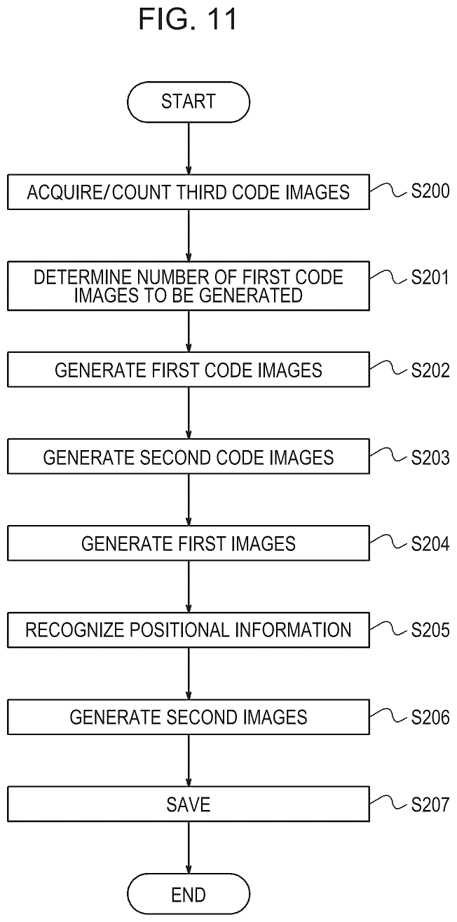

Referring to a flowchart in FIG. 11, description will be given with regard to a learning-data generation process performed by the controller 31 in the third information processing apparatus 26 in an embodiment. The learning-data generation process starts when the input unit 29 detects an operation input to generate learning data.

In step S200, the controller 31 acquires the third code images from the camera or another information processing apparatus via the input/output interface 27 or from the memory 30. The controller 31 counts the number of the third code images that are acquired. After the count, the process proceeds to step S201.

In step S201, the controller 31 determines the number of the first code images to be generated based on the number of the third code images counted in step S200. After the determination, the process proceeds to step S202.

In step S202, the controller 31 generates the first code images by encoding text information. The controller 31 generates the first code images using text information acquired by another information processing apparatus via the input/output interface 27 and acquired by the input unit 29, text information stored in the memory 30, or text information generated by the controller 31. The controller 31 generates the first code images, with the number of the first code images determined in step S201. After the generation, the process proceeds to step S203.

In step S203, the controller 31 generates the second code images by applying the first image processing to the third code images acquired in step S200 and the first code images generated in step S202. After the generation, the process proceeds to step S204.

In step S204, the controller 31 generates the first images by superposing the second code images generated in step S203 onto the background image. The controller 31 may acquire the background image from another information processing apparatus or a camera via the input/output interface 27, or from the memory 30. After the generation, the process proceeds to step S205.

In step S205, the controller 31 recognizes positional information of an area onto which each of the second code images is superposed in a respective one of the first images generated in step S204. After the recognition, the process proceeds to step S206.

In step S206, the controller 31 generates the second images by applying the second image processing to the first images generated in step S204. After the generation, the process proceeds to step S207.

In step S207, the controller 31 associates the positional information recognized in step S205 with each of the second images generated in step S206 and saves to the memory 30 the positional information and the second image in association with each other.

In an embodiment, the third information processing apparatus 26 constructed as above is configured to generate a first code image, apply first image processing to the first code image to generate a second code image, and generate a first image by superposing the second code image onto a background image. The accuracy of decoding a graphical code using the first information processing apparatus 18 described above improves as detection accuracy of a detection model increases. Training using many pieces of supervised data may improve the detection accuracy of the detection model. Creation of supervised data is troublesome because an operator needs to specify an area of a graphical code after capturing an image of a target. In contrast, the third information processing apparatus 26 constructed as above needs neither capturing an image of a graphical code nor specifying a position of the graphical code, and many pieces of supervised data for training may be generated with a small load. Thus, the third information processing apparatus 26 is able to improve the detection accuracy of the detection model, resulting in a contribution toward decoding a graphical code promptly and easily by the first information processing apparatus 18.

In the third information processing apparatus 26, the first image processing is at least one selected from the group consisting of rotation, enlargement or reduction, distortion, blurring, transparency processing, and local color change. When the imager 14 captures an image of a graphical code to be decoded, a partial image corresponding to the code has features such as a wide range of sizes, a wide range of directions, distortion due to bending of an article, distortion due to warping and bending of a package, blurring due to out-of-focus image capturing, transparency depending on a property of material to which the graphical code is attached, and partial whiteout caused by reflection of light from a light source. In response to such features, the third information processing apparatus 26 constructed as above is able to generate the second code image reflecting a feature that may be included in the code corresponding to the actual partial image. Thus, the third information processing apparatus 26 is able to generate learning data that further improves the detection accuracy of the detection model.

In the third information processing apparatus 26, the first image processing is configured to change transmittance of the first code image and thereby generate the second code image that allows the first code image to mix with the background image. When the imager 14 captures an image of a graphical code to be decoded, a partial image of the code may include, in the background, images of an article and a package containing the article due to transparency depending on a property of material to which the graphical code is attached.

In response to such a feature, the third information processing apparatus 26 constructed as above is able to generate the second code image reflecting the feature that may be included in the code corresponding to the actual partial image. Thus, the third information processing apparatus 26 is able to generate learning data that further improves the detection accuracy of the detection model.

In the third information processing apparatus 26, the background image includes an image of an article, and the first image processing is configured to generate the second code image in which a graphical code is changed in accordance with a three-dimensional shape of the article. When the imager 14 captures an image of a graphical code to be decoded, a partial image is generated in which the code is also subjected to distortion or the like due to warping and bending of the article. In response to such a feature, the third information processing apparatus 26 constructed as above is able to generate the second code image reflecting the feature that may be included in the code corresponding to the actual partial image. Thus, the third information processing apparatus 26 is able to generate learning data that further improves the detection accuracy of the detection model.

In the third information processing apparatus 26, the background image includes an image of a package, and the first image processing is configured to generate the second code image in which a graphical code is changed in accordance with a three-dimensional shape of the package. When the imager 14 captures an image of a graphical code to be decoded, a partial image is generated in which the code is also subjected to distortion or the like due to warping and bending of the package. In response to such a feature, the third information processing apparatus 26 constructed as above is able to generate the second code image reflecting the feature that may be included in the code corresponding to the actual partial image. Thus, the third information processing apparatus 26 is able to generate learning data that further improves the detection accuracy of the detection model.

The third information processing apparatus 26 is configured to generate a second image by applying second image processing to the first image, and the second image processing changes at least one of color or contrast of the first image as a whole. When the imager 14 captures an image of a graphical code to be decoded, appearance may depend on illumination light to illuminate a graphic. In response to such a feature, the third information processing apparatus 26 constructed as above is able to generate the second image reflecting the feature that may be included in the actual partial image. Thus, the third information processing apparatus 26 is able to generate learning data that further improves the detection accuracy of the detection model.

The third information processing apparatus 26 is configured to acquire a third code image and generate the first image based on the third code image. In such a configuration, the third information processing apparatus 26 is able to generate learning data that improves the detection accuracy of an area corresponding to a graphical code in an image that actually captures a product or the like having the graphical code.

The third information processing apparatus 26 is configured to determine the number of the first code images to be generated based on the number of the third code images that are acquired. In such a configuration, the third information processing apparatus 26 is configured to refrain from generating an unlimited number of the first code images relative to the number of the third code images that are generated by actual image capturing. Thus, the third information processing apparatus 26 is able to generate learning data that further improves the detection accuracy of an area corresponding to a graphical code in an image that actually captures a product or the like having the graphical code.

The third information processing apparatus 26 is configured to generate the second code image by applying the first image processing to the third code image. In such a configuration, the third information processing apparatus 26 is able to provide various kinds of learning data by generating images obtained by deforming an actually captured image.

Thus, the third information processing apparatus 26 is able to generate learning data that further improves the detection accuracy of the detection model.

In an embodiment, the first information processing apparatus 18 includes the communicator 19 configured to acquire a captured image ci and the controller 20 configured to extract a partial image corresponding to a graphical code by entering the captured image ci into a detection model and decode the code based on the extracted partial image, and the detection model is the learning model described above. The first information processing apparatus 18 is configured to perform decoding based on the captured image ci without using a dedicated scanner, dispensing with alignment and positioning, and thus is able to decode the code in a simple way.

In the first information processing apparatus 18, the controller is configured to enter into the detection model a low-resolution image Iri obtained by reducing a resolution of the captured image ci, thereby detect an area of a partial image pia in the low-resolution image Iri, and decode the code based on the detected partial image. By using the low-resolution image Iri to detect the partial area corresponding to a graphical code, the first information processing apparatus 18 is able to perform detection promptly.

In an embodiment, (1) a method of generating learning data includes
generating a first code image that is a graphical code;
generating a second code image by applying first image processing to the first code image; and generating a first image by superposing the second code image onto a background image.

(2) In the method of generating learning data described in (1),
the first image processing is at least one selected from the group consisting of rotation, enlargement or reduction, distortion, blurring, transparency processing, and local color change.

(3) In the method of generating learning data described in (1) or (2),
the background image includes images of an article and a package containing the article, and
the first image processing is configured to generate the second code image that allows one of or both of the article and the package to be visible through the graphical code, the article and the package being in a background.

(4) In the method of generating learning data described in (3),
the first image processing is configured to change transmittance of the first code image and thereby generate the second code image that allows the first code image to mix with the background image.

(5) In the method of generating learning data described in (1) to (4),
the background image includes an image of an article, and
the first image processing is configured to generate the second code image in which the graphical code is changed in accordance with a three-dimensional shape of the article.

(6) In the method of generating learning data described in (1) to (5),
the background image includes an image of a package, and
the first image processing is configured to generate the second code image in which the graphical code is changed in accordance with a three-dimensional shape of the package.

(7) The method of generating learning data described in (1) to (6) includes
generating a second image by applying second image processing to the first image, and
the second image processing is changing at least one of color or contrast of the first image as a whole.

(8) The method of generating learning data described in (1) to (7) includes
acquiring a third code image that is a graphical code; and
generating the first image based on the third code image.

(9) In the method of generating learning data described in (8),
a number of the first code images to be generated is determined based on a number of the third code images that are acquired.

(10) The method of generating learning data described in (8) or (9) includes generating the second code image by applying the first image processing to the third code image.

(11) The method of generating learning data described in (8) or (9) includes
generating the first image by superposing the third code image onto the background image.

(12) A learning model to which the method of generating learning data described in (7) is applied is configured to
cause a computer to, in response to an image being input, output an area of a partial image corresponding to a graphical code in the image, the learning model being trained using the second image generated by the method of generating learning data.

(13) A learning model to which the method of generating learning data described in (1) to (11) is applied is configured to
cause a computer to, in response to an image being input, output an area of a partial image corresponding to a graphical code in the image, the learning model being trained using the first image generated by the method of generating learning data.

In an embodiment, (14) an information processing apparatus includes
an acquirer configured to acquire a captured image that has been captured; and
a controller configured to extract an area of a partial image corresponding to a graphical code by entering the captured image into a detection model and decode the code based on the extracted partial image,
and the detection model is the learning model described in (12) or (13).

(15) In the information processing apparatus described in (14),
the controller is configured to enter a low-resolution image into the detection model, thereby detect an area of the partial image in the low-resolution image, and decode the code based on the detected partial image, the low-resolution image being obtained by reducing resolution of the captured image.

In an embodiment, (16) a method of processing information includes
acquiring a captured image that has been captured;
extracting a partial image corresponding to a graphical code by entering the captured image into a detection model; and
decoding the code based on the extracted partial image, and the detection model is the learning model described in (12) or (13).

In an embodiment, (17) a method of generating learning data includes
generating a first code image to be used to identify an attribute of an article;
generating a second code image by applying first image processing to the first code image; and
generating a learning image by superposing the second code image onto a background image including the article and a package containing the article, and
the first image processing is configured to reproduce a manner in which at least one of the article or the package containing the article is visible through the first code image.

In an embodiment, the first information processing apparatus 18 and the third information processing apparatus 26 have been described, but an embodiment of the present disclosure may be practiced in a form of a method or a program to implement such apparatuses and further in a form of a recording medium storing a program (for example, an optical disc, a magneto-optical disc, a CD-ROM, a CD-R, a CD-RW, a magnetic tape, a hard disk, or a memory card).

Such a program may be implemented in a form of not only an application program, such as an object code to be compiled by a compiler or a program code to be executed by an interpreter, but also a program module and the like to be built into an operating system. Such a program may or may not be configured so that all the processes are executed only by a CPU on a control board. Such a program may be configured so that part or all of the program is executed by another processing unit implemented on an expansion board or an expansion unit added to the board, as necessary.

The figures are schematically drawn to describe an embodiment of the present disclosure. The dimensions, proportions, and the like in the figures do not necessarily represent the actual ones.

An embodiment of the present disclosure has been described based on the drawings and the example. Note that those skilled in the art are able to perform various variations or alterations based on the present disclosure. Accordingly, note that those variations or alterations are within the scope of the present disclosure. For example, a function or the like included in each constituent or the like may be rearranged in a logically compatible manner, and combining multiple constituents or the like into one or dividing a constituent or the like is possible.

For example, in an embodiment described above, the controller 31 in the third information processing apparatus 26 is configured to generate the second image based on the first code image and the third code image. However, the controller 31 may generate the second image based on only one of the first code image or the third code image.

For example, in an embodiment described above, the controller 31 in the third information processing apparatus 26 is configured to generate the second image by applying the second image processing to the first image obtained by superposing onto the background image the second code image subjected to the first image processing. However, the controller 31 may generate the second image by further applying the second image processing to the second code image without superposing the second code image onto the background image.

For example, in an embodiment described above, the first code image is generated to detect a graphical code. However, the controller 31 may generate the first code image of a code to be used to identify an attribute of an article, such as a price tag or a sticker indicating a discount, generate the second code image by applying the first image processing to the first code image, and generate a learning image by superposing the second code image onto the background image. Supervised data to be used in this case may be a combination of an image including, as a partial image, a product having, on a surface, a code to be used to identify an attribute of an article and information indicating the position of the code.

All the elements described in the present disclosure and/or all the steps in all the methods or processes disclosed may be combined in any way except in a combination where these features are mutually exclusive. Each of the features described in the present disclosure may be replaced with an alternative feature workable for the same target, an equivalent target, or a similar target unless such replacement is explicitly denied. Thus, each of the disclosed features is just an example of an inclusive series of the same or equivalent features unless explicitly denied.

Further, an embodiment of the present disclosure is not limited by any of the specific configurations of an embodiment described above. An embodiment of the present disclosure may be expanded to all the new features described in the present disclosure or a combination thereof, or all the new methods or process steps described or a combination thereof.

In the present disclosure, expressions such as “first” and “second” are identifiers to distinguish the configurations. Ordinal numbers assigned to the configurations may be exchanged between the configurations distinguished by the expressions such as “first” and “second” in the present disclosure. For example, the identifiers “first” and “second” may be exchanged between the first information processing apparatus and the second information processing apparatus. The identifiers are exchanged simultaneously. The configurations are distinguished after the exchange of the identifiers. The identifiers may be removed. The configurations are distinguished by symbols after the identifiers are removed. Neither the order of the configurations nor the presence of an identifier having a small number is to be assumed only based on the expressions of the identifiers such as “first” and “second” in the present disclosure.

### REFERENCE SIGNS

10 information processing system
11 terminal
12 network
13 second information processing apparatus
14 imager
15 output device
16 platen
17 supporting stand
18 first information processing apparatus (information processing apparatus)
19 communicator (acquirer)
20 controller
21 memory
22 input unit
23 communicator
24 memory
25 controller
26 third information processing apparatus
27 input/output interface
28 output unit
29 input unit
30 memory
31 controller
ci captured image
lri low-resolution image
pia area of a partial image corresponding to a graphical code
us upper surface

1. A method of generating data, the method comprising:
generating a first code image that is a graphical code;
generating a second code image by applying first image processing to the first code image; and
generating a first image by superposing the second code image onto a background image.

2. The method of generating data according to claim 1,
wherein the first image processing is at least one selected from the group consisting of rotation, enlargement or reduction, distortion, blurring, transparency processing, and local color change.

3. The method of generating data according to claim 1,
wherein the background image includes images of an article and a package containing the article, and
the first image processing is configured to generate the second code image that allows one of or both of the article and the package to be visible through the graphical code, the article and the package.

4. The method of generating data according to claim 3,
wherein the first image processing is configured to change transmittance of the first code image and thereby generate the second code image that allows the first code image to mix with the background image.

5. The method of generating data according to claim 1,
wherein the background image includes an image of an article, and
the first image processing is configured to generate the second code image in which the graphical code is changed in accordance with a three-dimensional shape of the article.

6. The method of generating data according to claim 1,
wherein the background image includes an image of a package, and
the first image processing is configured to generate the second code image in which the graphical code is changed in accordance with a three-dimensional shape of the package.

7. The method of generating data according to claim 1, the method further comprising:
generating a second image by applying second image processing to the first image,
wherein the second image processing is changing at least one of color or contrast of the first image as a whole.

8. The method of generating data according claim 1, the method further comprising:
acquiring a third code image that is a graphical code; and
generating the first image based on the third code image.

9. A learning model configured to cause a computer to
in response to an image being input, output an area of a partial image corresponding to a graphical code in the image, the learning model being trained using the second image generated by the method of generating data according to claim 7.

10. A learning model configured to cause a computer to
in response to an image being input, output an area of a partial image corresponding to a graphical code in the image, the learning model being trained using the first image generated by the method of generating data according to claim 1.

11. An information processing apparatus comprising:
an acquirer configured to acquire a captured image that has been captured; and
a controller configured to extract a partial image corresponding to a graphical code by entering the captured image into the learning model according to claim 9 and decode the code based on the extracted partial image.

12. The information processing apparatus according to claim 11, wherein the controller is configured to enter a low-resolution image into the learning model, thereby detect an area of the partial image in the low-resolution image, and decode the code based on the detected partial image, the low-resolution image being obtained by reducing resolution of the captured image.

13. A method of processing information, comprising:
acquiring a captured image that has been captured;
extracting a partial image corresponding to a graphical code by entering the captured image into the learning model according to claim 9; and
decoding the code based on the extracted partial image.

14. A method of generating learning data, the method comprising:
generating a first code image to be used to identify an attribute of an article;
generating a second code image by applying first image processing to the first code image; and
generating a learning image by superposing the second code image onto a background image including images of the article and a package containing the article,
wherein the first image processing is configured to reproduce a manner in which at least one of the article or the package containing the article is visible through the first code image.
